(19) United States
(12) Patent Application Publication
(10) Pub. No.: US 2023/0306566 A1
(43) Pub. Date: Sep. 28, 2023

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: HIROKAZU TAKAHASHI, Tokyo (JP)

(21) Appl. No.: 18/186,004

(22) Filed: Mar. 17, 2023

(30) Foreign Application Priority Data
Mar. 24, 2022 (JP) 2022-048205

(51) Int. Cl. G06T 5/00; G06T 7/80; G06T 7/593

(52) U.S. Cl. CPC G06T 5/006; G06T 7/85; G06T 7/593; G06T 2207/30252; G06T 2207/10012

(57) ABSTRACT

In an apparatus, a first image and a second image having parallax in a first direction are acquired, correlation information between an image of a fiducial region in the first image and an image of a reference region corresponding to the fiducial region in a second image is acquired, the correlation information is corrected based on a distance in a second direction orthogonal to the first direction, between the fiducial region and the reference region, and an image deviation amount between an image of the fiducial region and an image of the reference region is calculated based on the corrected correlation information.

### BACKGROUND

### Technical Field

One aspect of the embodiments relates to an image processing apparatus, an image processing method, a storage medium, and the like.

### Description of the Related Art

A technology is known in which, in a digital camera that is mounted as an information acquisition sensor for automated guided vehicles or industrial robots, distance measuring pixels are arranged on an imaging element, and a distance to an object is detected by using the phase difference method.

In such a method, a configuration is adopted in which a plurality of photoelectric conversion units is arranged in the distance measurement pixels, and a light flux that has passed through different regions above a pupil of a photographic lens is guided to different photoelectric conversion units.

Optical images generated by the light flux that has passed through different pupil regions (hereinafter, respectively referred to as an “A image” and a “B image”) can be acquired by signals that have been output from the photoelectric conversion unit included in each of the distance measurement pixels, and a plurality of images can be acquired based on each of the A image and the B image. Note that the pupil regions corresponding to the A image and the pupil regions corresponding to the B image are deviated in a direction along a “pupil-division direction”.

Additionally, relative positional deviation according to a defocus amount occurs between the acquired images (hereinafter, respectively referred to as the “A image” and the “B image”) along the pupil-division direction. This positional deviation is referred to as “image deviation”, and a distance to an object can be calculated by converting the image deviation amount, which is the amount of image deviation, into a defocus amount via a predetermined conversion coefficient.

According to such a method, unlike in conventional contrast methods, since there is no need to move the lens in order to measure the distance, rapid and highly accurate distance measurement is possible.

A region-based corresponding point search technique, which is widely referred to as “template matching”, is used to calculate image deviation amounts. In template matching, one of the A image or the B image is used as a fiducial image, and the other image is used as a reference image.

Additionally, a fiducial region around a point of interest is set in the fiducial image, and a reference region around a reference point corresponding to the point of interest is also set in the reference image. The reference point is sequentially moved while searching for the point at which the correlation between the fiducial region of the A image and the reference region of the B image is at the highest. The image deviation amount is calculated based on the relative positional deviation amount between this point and the point of interest.

In the template matching, when the reference point is sequentially moved while searching for the point at which the correlation is at the highest, the search is performed along the direction in which the image deviation occurs. For example, when a sensor is disposed in such a manner that image deviation occurs in the horizontal direction, this search is performed in the horizontal direction.

However, there are cases in which the light flux that has passed through the photographic lens causes image deviation in an unintended direction (in the above example, the vertical direction) due to an error in the optical system. Additionally, there is a possibility that this error will not be fixed during manufacturing, and that this error may fluctuate at any time due to, for example, heat.

When image deviation occurs in the vertical direction, there is a possibility that the calculation of the image deviation amount and the distance measurement will not be able to be performed correctly depending on the images within the reference region used in the template matching. For example, when an object consisting of oblique lines is included in an image, image deviation in the vertical direction is interpreted as image deviation in the horizontal direction, and the image deviation amount that has been interpreted as horizontal image deviation is added as a distance measurement value.

In Japanese Patent Application Laid-Open No. 2012-194069, a search performed by changing the reference point in the vertical direction is also performed, and when the image deviation amount is significantly different between the case in which the reference point has been changed and the case in which the reference point has not been changed, it is determined that the degree of reliability is low, and the distance measurement result is discarded.

Although the method that is disclosed in Japanese Patent Application Laid-Open No. 2012-194069 can be applied to cases of obtaining distances corresponding to objects, the method cannot be applied to cases in which it is desirable that distance measurement results are obtained for each pixel.

In order to correct image deviation in the vertical direction due to an error in an optical system, there is a method that also performs a search by template matching in the vertical direction in addition to in the horizontal direction, and that searches for a position where the correlation becomes high. In this case, although an image deviation amount can be calculated correctly when an object in which the correlation tends to be high is included in the reference region, there is a drawback in which when an object consisting of oblique lines is included in the reference region, the position where the correlation is high is not uniquely determined, and as a result, the image deviation amount cannot be calculated correctly.

### SUMMARY

An apparatus according to one aspect of the embodiments comprises at least one processor and a memory coupled to the at least one processor storing instructions that, when executed by the at least one processor, cause the at least processor to function as: an image acquisition unit configured to acquire a first image and a second image having parallax in a first direction; a correlation acquisition unit configured to acquire correlation information between an image of a fiducial region in the first image and an image of a reference region corresponding to the fiducial region in a second image; a correction unit configured to correct the correlation information based on a distance in a second direction orthogonal to the first direction, between the fiducial region and the reference region; and an image deviation amount calculation unit configured to calculate an image deviation amount between an image of the fiducial region and an image of the reference region, based on the corrected correlation information.

Further features of the present disclosure will become apparent from the following description of embodiments with reference to the attached drawings.

### BRIEF DESCRIPTION OF THE DRAWINGS

FIG. 1 is a functional block diagram showing the overall configuration of a distance measuring device 100 serving as an image processing apparatus according to the first embodiment.

FIG. 2 is a diagram showing an example of an operation in a correlation calculation unit that takes horizontal deviation into consideration.

FIG. 3 is a diagram showing an example of an operation in a correlation calculation unit that takes horizontal and vertical deviations into consideration.

FIG. 4 is a diagram for explaining an example of a drawback that occurs when horizontal and vertical deviations are taken into consideration in the correlation calculation unit.

FIG. 5 is a diagram for explaining another example of a drawback that occurs when the horizontal and vertical deviations are taken into consideration in the correlation calculation unit.

FIG. 6A and FIG. 6B are diagrams for explaining examples of correction of the degree of difference in a correlation calculation unit 108 according to the first embodiment.

FIG. 7A and FIG. 7B are diagrams showing another example of correction of the degree of difference in the correlation calculation unit.

FIG. 8 is an example of a deviation amount fiducial value map 800 stored in a storage unit 112.

FIG. 9 is a flow chart showing the control flow in the first embodiment.

FIG. 10A and FIG. 10B are diagrams showing examples of degree of difference correction in which vertical deviation is detected in the correlation calculation unit according to the second embodiment.

FIG. 11 is a diagram showing the control flow in the second embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate descriptions will be omitted or simplified.

Note that, in the embodiments, an example of applying an image processing apparatus to a camera mounted on a movable apparatus such as an automobile will be described. However, the image processing apparatus in the embodiments includes electronic devices such as digital still cameras, digital movie cameras, smartphones with cameras, tablet computers with cameras, network cameras, drone cameras, cameras mounted on robots, and the like.

### First Embodiment

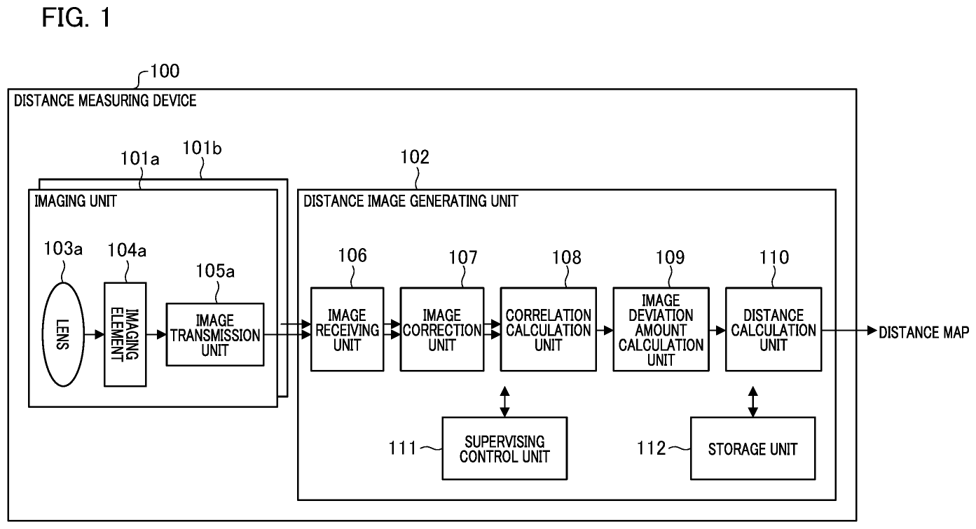

FIG. 1 is a functional block diagram showing the overall configuration of a distance measuring device 100 serving as an image processing apparatus according to the first embodiment. Note that a part of the functional blocks shown in FIG. 1 are realized by causing a computer (not illustrated) that is included in an image processing apparatus to execute a computer program stored in a memory serving as a storage medium (not illustrated).

However, a part or all of these may be realized by hardware. A dedicated circuit (ASIC), a processor (reconfigurable processor, DSP), and the like can be used as the hardware. Additionally, each functional block shown in FIG. 1 is not necessarily built into the same housing, and may be configured by separate devices that are connected to each other via a signal line.

In the first embodiment, the distance measuring device 100 is mounted on a movable apparatus, for example, an automobile and the like, and the imaging unit is configured as a stereo camera. The distance measuring device 100 has at least two of an imaging unit 101a and an imaging unit 101b that are arranged to be separated by a predetermined interval (baseline length) in a predetermined direction (first direction) so that triangulation for a distance to an object in each pixel of the photographed image is performed.

Hereinafter, an image that is obtained by the imaging unit 101a, and which is used as a reference image, is referred to as an “A image” or a “first image”, and an image obtained by the imaging unit 101b is referred to a “B image” or a “second image”. The first image and the second image have parallax in the first direction, as described above.

Reference numeral 102 denotes a distance image generating unit that generates a distance map indicating a distance between each pixel, based on the image received from the imaging unit 101. The distance image generating unit 102 is configured by, for example, an LSI, a CPU serving as a computer, a memory that stores a computer program executed by the CPU, various IOs, and the like, and the method of its configuration is not particularly limited.

Note that the distance image generating unit 102 is not necessarily mounted on a movable apparatus, for example, an automobile and the like, and it may be, for example, a PC terminal, a tablet, or the like that is placed at a distance away from a movable apparatus, such as, for example, an automobile.

Reference numeral 103a denotes a lens that forms an object image on an imaging element 104a. The imaging element 104a is an image sensor configured by a CMOS (Complementary Metal Oxide Semiconductor) or a CCD (Charge Coupled Device).

An object image formed on the imaging element 104a via the lens 103a is converted into an electrical signal by the imaging element 104a. Reference numeral 105a denotes an image transmission unit for transmitting electrical signals which have been obtained by the imaging element 104a, to the distance image generating unit 102 to serve as the image data for the A image.

Note that, although, in FIG. 1, the lens 103a, the imaging element 104a, and the image transmission unit 105a that are provided in the imaging unit 101a are shown, a lens 103b, an imaging element 104b, and an image transmission unit 105b that respectively correspond to the lens 103a, the imaging element 104a, and an image transmission unit 105a are provided in the imaging unit 101b.

Image data for the image B are generated by the imaging unit 101b, and the image data are transmitted from the image transmission unit 105b to the distance image generating unit 102.

Note that the configuration may be partially shared between the imaging unit 101a and the imaging unit 101b. A configuration may be adopted, in which, for example, a distance measuring pixel having a distance measuring function is disposed on a part or all of the pixels of the imaging element, and, for example, two photoelectric conversion units are disposed in each of the distance measuring pixels, and light flux that has passed through different regions on the pupil of the lens is guided to each of the photoelectric conversion units. In that case, the lens and the image transmission units can be shared.

An image receiving unit 106 receives each of the image data of the A image and the B image transmitted from the imaging unit 101. Specifically, the image receiving unit 106 functions as an image acquisition unit that acquires a first image and a second image having parallax in the first direction.

An image correction unit 107 performs the pre-processing for generating a distance map on the image data that has been transmitted from the image receiving unit 106. The pre-processing includes, for example, shading correction for correcting uneven luminance due to a decrease in marginal illumination caused by the lens 103a and the lens 103b, and filter processing for enhancing correlation.

The correlation calculation unit 108 calculates the correlation between the A image and the image B at each pixel position by performing template matching, and the like, for a predetermined search range, and the method therefor will be described below. An image deviation amount calculation unit 109 calculates an image deviation amount at each pixel position by selecting the correlation distance with the highest correlation based on the correlation that has been calculated by the correlation calculation unit 108.

Note that, if necessary, interpolation may also be performed for resolutions below the search resolution by parabolic fitting and the like. Furthermore, if necessary, the calculated image displacement amount may also be offset by the known image deviation amount in the parallax direction that occurs uniquely in the image processing apparatus. Additionally, it may be possible to perform offset for the image deviation amount caused by the refractive index of the optical system, based on the contrast of color information included in the image.

A distance calculation unit 110 calculates a distance to the object at each pixel position by using the image deviation amount that has been calculated by the image deviation amount calculation unit 109 and the interval (baseline length) between the two lenses 103a and 103b. It is possible to generate a distance map for the full-image by performing the calculation of the above distance over the full-image.

Additionally, the distance image generating unit 102 includes a supervising control unit 111 that controls the control of each unit, and the storage unit 112 for holding operation setting values of each unit and buffering intermediate data appropriately. Additionally, a CPU serving as a computer is built into the supervising control unit 111 and functions as a control unit that controls the operation of each unit of the entire distance measuring device based on a computer program stored in the storage unit 112, which serves as a storage medium.

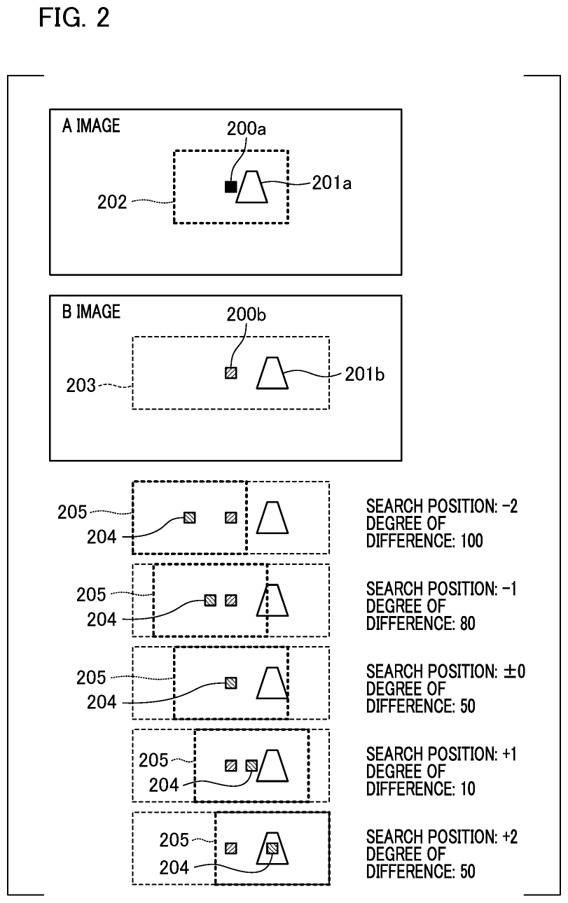

FIG. 2 is a diagram showing an example of an operation in the correlation calculation unit that takes horizontal deviation into consideration, and in which an example of an operation that does not take vertical deviation, which is to be described below, into consideration is shown. Reference numeral 200a denotes a fiducial position in which distance calculation is to be performed on the A image. Reference numeral 200b denotes a corresponding fiducial position showing the coordinates that are the same as those for 200a on the B image.

Reference numeral 201a denotes an example of an object imaged on the A image, and reference numeral 201b denotes an object indicating the object that is the same as that of 201a, which is imaged on the B image. 201a and 201b are present at different coordinate positions depending on the interval (baseline length) of arrangement of the two lenses 103a and 103b and the distance to the object.

Here, it is assumed that the two lenses 103a and 103b are arranged to be spaced in the horizontal direction, and 201a and 201b are imaged in the state of being deviated in the horizontal direction. For example, template matching is performed to calculate this deviation amount.

Reference numeral 202 denotes a fiducial region that is used for performing the template matching. Reference numeral 203 denotes a horizontal search region that is used for searching for an image in which the correlation with the fiducial region 202 is high on the B image. Since deviation occurs in the horizontal direction, the search region is long in the horizontal direction.

Reference numeral 204 denotes a plurality of reference positions on the B image side, where the template matching is performed. Reference numeral 205 denotes a plurality of reference regions including peripheral pixels at each of the reference positions 204. In this case, an example of searching for five positions that serve as search positions, and that are deviated by −2, −1, ±0, +1 and +2 is shown.

Although the correlation is calculated at each of these positions, for example, SSD (Sum of Squared Divide) is used, which is a known method in which the square sum of the differences between pixel values in the fiducial region 202 and the reference region 205 is assumed to be the degree of difference.

In the method using SSD, the calculated value is the degree of difference, where a portion where the degree of difference is the lowest is a position where the correlation is the highest. In the first embodiment, the explanation will be given by using an example in which the degree of difference is specifically used for the calculation of the correlation, and the correlation is high when the degree of difference is low.

In the example in FIG. 2, in the subsequent stage, the image in the reference region at the position where the degree of difference is 10 and the search position is +1 is determined to be the most similar (highly correlated) to the image in the fiducial region 202 by the image deviation amount calculation unit 109.

Then, the distance is calculated by the distance calculation unit 110 based on the information indicating a deviation of +1. Specifically, the fiducial region in the first image includes a plurality of fiducial positions set in the first image, and the image deviation amount is determined for each of the plurality of fiducial positions.

Additionally, a reference region in the second image includes a plurality of reference positions set in the second image, and correlation information is obtained for each of the plurality of reference positions corresponding to the fiducial positions.

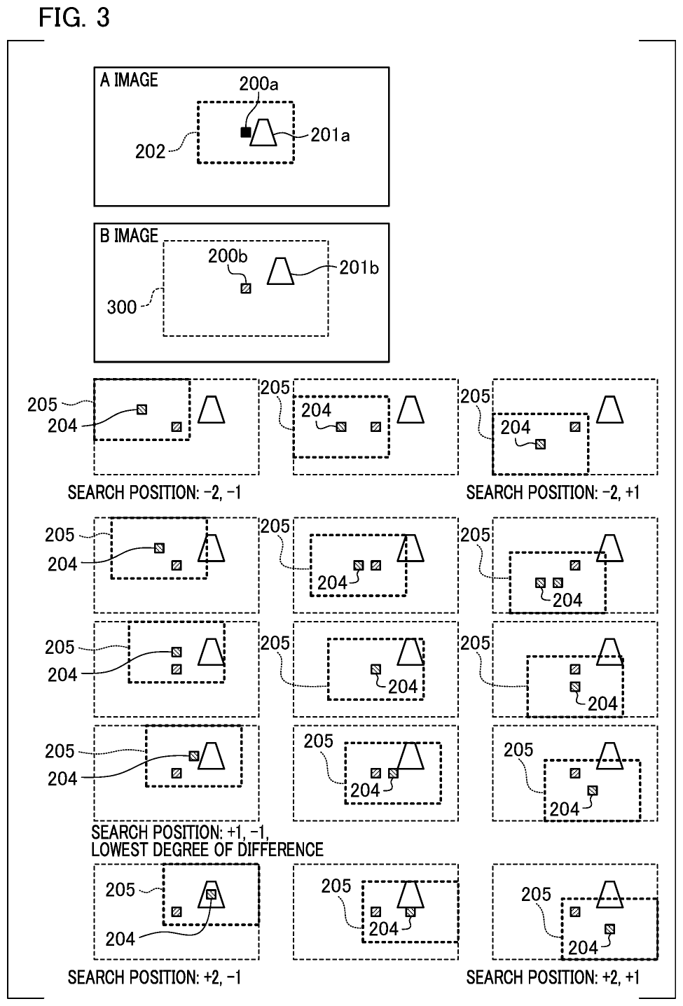

FIG. 3 is a diagram showing an example of operations in the correlation calculation unit that take into consideration horizontal and vertical deviations. In FIG. 2, the template matching is performed on the assumption that the A image and the B image have parallax in the horizontal direction (first direction).

However, in the example of FIG. 3, it is assumed that the A image and the B image are also deviated in the vertical direction (the second direction orthogonal to the first direction) due to an error in the optical system, and the objects 201a and 201b are imaged in a state in which they are deviated in the vertical direction in addition to the horizontal direction.

Reference numeral 300 denotes a two-dimensional search region used for searching for an image region similar to the image of the fiducial region 202 on the B image. That is, in FIG. 3, a plurality of reference positions is set in each of the first direction and the second direction.

The meanings of the other reference numerals are the same as those in FIG. 2. In FIG. 3, the search is performed while deviating the search position from −2 to +2 in the horizontal direction and deviating this from −1 to +1 in the vertical direction.

In FIG. 3, “search position: −2, −1” indicates that the search position is deviated by −2 in the horizontal direction and +1 in the vertical direction, and the degree of difference is the lowest in the “search position: +1, −1”. That is, the degree of difference is the lowest (the correlation is the highest) at the position where the horizontal search position is +1 and the vertical search position is −1.

In the image deviation amount calculation unit 109, the image of the reference region at this position is determined to be most similar to the image of the fiducial region 202, and in the distance calculation unit 110, a distance is calculated by using a horizontal search position value of +1 as the image deviation amount.

Thus, in the correlation calculation unit, correlation information (the degree of difference) is obtained between the image of the fiducial region in the first image and the image of the reference region corresponding to the fiducial region in the second image.

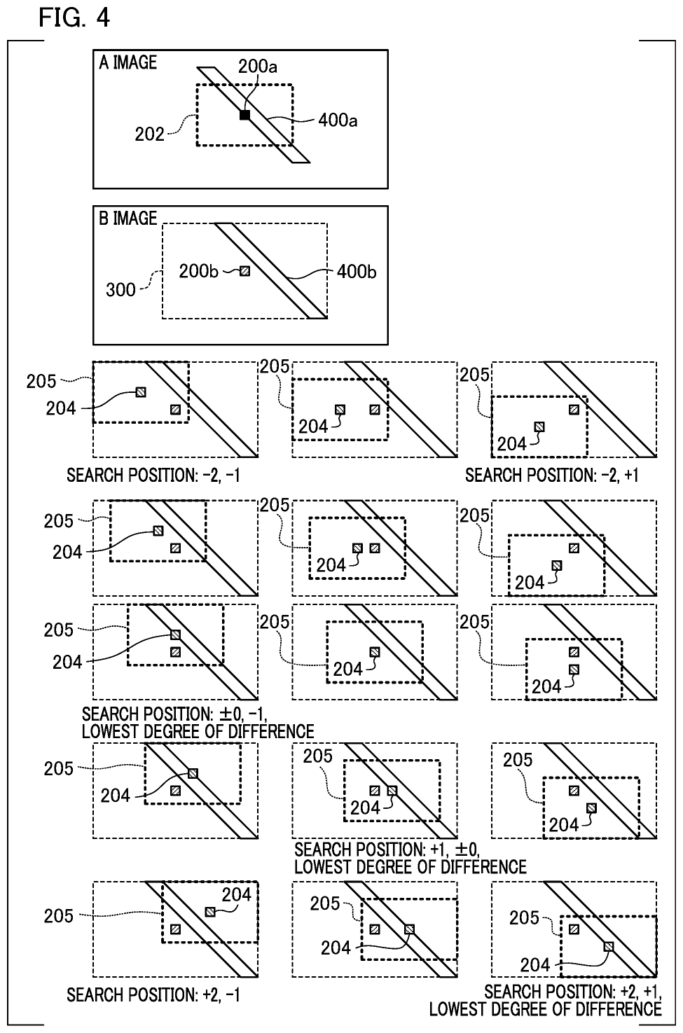

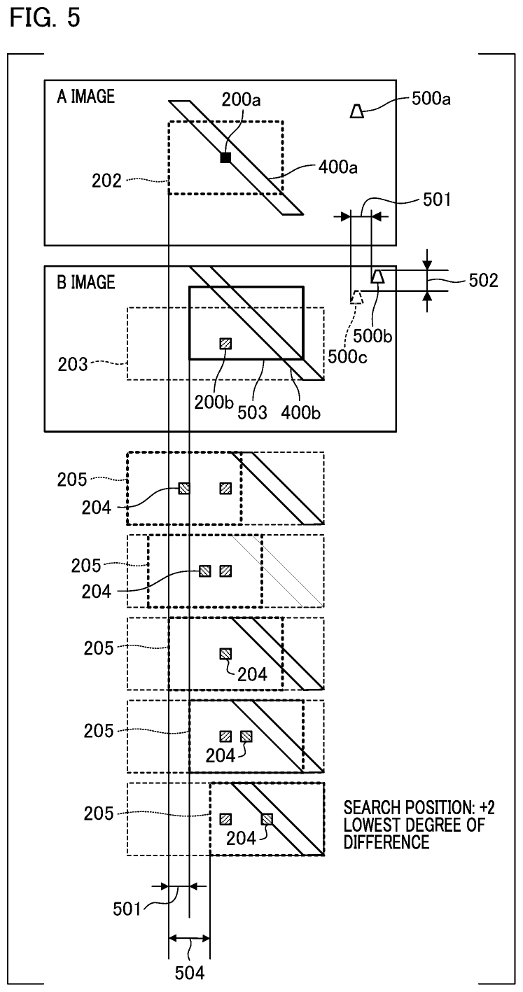

The operation for the correlation calculation unit 108 described above is effective when an appropriate object can be obtained by the template matching. However, for example, when an object consisting of an oblique line is included, this operation becomes inconvenient. The following examples will be described with reference to FIG. 4 and FIG. 5.

FIG. 4 is a diagram for explaining an example of a drawback that occurs when horizontal and vertical deviations are taken into consideration in the correlation calculation unit. It is characteristic of the example shown in FIG. 4 that the object includes an oblique line that is unsuitable for template matching.

Note that, in the example shown in FIG. 4, the two-dimensional search region 300 is used as a countermeasure to the deviation in the vertical direction. Reference numeral 400a denotes an oblique line object imaged on the A image, and reference numeral 400b denotes an oblique line object indicating an object that is the same as 400a that is imaged on the B image.

The amount of deviation that actually occurs between these oblique line objects 400a and 400b is (horizontal direction, vertical direction)=(+1, ±0). However, in this example, when each of the degrees of difference is calculated by using a plurality of reference regions 205 a plurality of candidates for search positions where the degree of difference is the lowest is found.

Specifically, although the deviation amount that is expected to be detected is (horizontal direction, vertical direction)=(+1, ±0), the resulting values for the degree of difference are similar even when the search positions are (±0, −1) and (+2, +1) because the object consists of oblique lines, and as a result, the correct deviation amount is not determined.

FIG. 5 is a diagram for explaining another example of a drawback that occurs when horizontal deviation and vertical deviation are taken into consideration in the correlation calculation unit. The characteristics of the example shown in FIG. 5 are that the object consists of oblique lines unsuitable for the template matching and has deviation in the vertical deviation due to an error in the optical system, in addition to the deviation in the horizontal direction due to parallax.

Note that, although, in the example in FIG. 4, the occurrence of a plurality of image deviation amount candidates due to performing a search by template matching in the vertical direction has been explained, in the example in FIG. 5, the occurrence of another drawback that occurs even when template matching in the vertical direction is not performed will be explained.

In FIG. 5, deviation amounts actually occur in both the horizontal and vertical directions, and this state is explained by sample objects 500a, 500b, and a copy object 500c. 500a denotes a sample object that is imaged on the A image, and 500b is a sample object indicating the same object as 500a imaged on the B image.

Reference numeral 500c denotes a copy object showing the sample object 500a on the A image at the same coordinates on the image B. According to the copy object 500c and the sample object 500b, the deviation amount that occurs on the B image is an actual horizontal deviation 501 (for example, +1) and an actual vertical deviation 502 (for example, −1).

Based on the actual horizontal deviation 501 and the actual horizontal deviation 502, the position on the B image originally corresponding to the fiducial region 202 is an ideal corresponding region 503. However, when a search is performed in the horizontal search region 203, it is determined that the position where the degree of difference is the lowest is the position at the horizontal search position +2.

The horizontal deviation 504 (in this example, +2) that is calculated as a result is different from the actual horizontal deviation 501 (in this example, +1), and consequently, a correct distance calculation is not possible.

As described above, in the case in which the template matching is to be performed in the vertical direction as well so as to correct vertical deviation due to the optical system, a plurality of candidates where the degree of difference becomes low occurs when an oblique line object is present. In contrast, if a search for vertical deviation is not performed at all, when an oblique line object is present, there are cases in which a horizontal deviation that is different from the actual horizontal deviation is calculated.

Therefore, in the first embodiment, errors are suppressed by correcting the degree of difference for the template matching in the vertical direction.

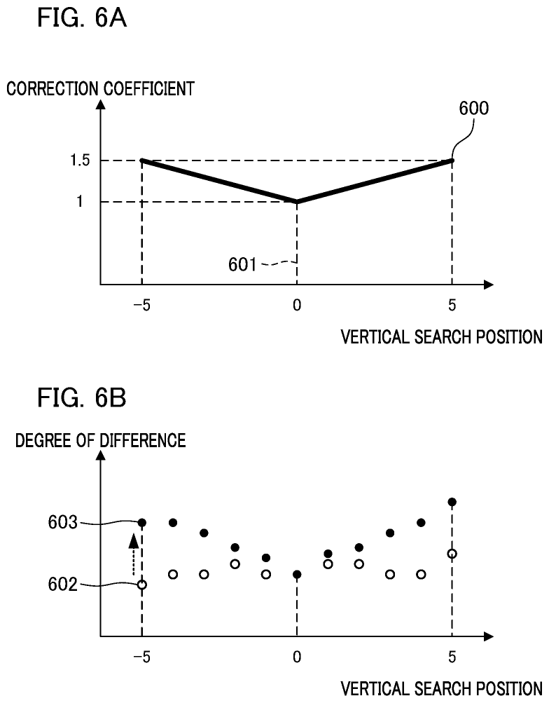

FIG. 6A and FIG. 6B are diagrams for explaining an example of the correction of the degree of difference in the correlation calculation unit 108 according to the first embodiment.

FIG. 6A is a diagram showing an example of a correction coefficient 600 by which the degree of difference is multiplied. When a two-dimensional search is performed, as is shown in FIG. 4, the degree of difference that is calculated according to the search position in the vertical direction (the second direction orthogonal to the first direction) is multiplied by a coefficient.

Reference numeral 601 denotes a deviation amount fiducial value, and in this case, the deviation amount fiducial value 601 is set to the vertical search position ±0. The magnification for the degree of difference calculated by the deviation amount fiducial value 601 is set to 1, and the magnification for the degree of difference calculated with the vertical search position ±5 is set to 1.5, and the midpoint is made to be linear.

Specifically, by increasing the degree of difference by multiplying the degree of difference by a correction coefficient with a greater weight, the further away the search position is from the deviation fiducial value 601, the smaller the correlation is made. Thus, in the first embodiment, the correlation information is made smaller (the degree of difference is made larger) as the distance between the fiducial region and the reference region in the second direction becomes farther away from the predetermined fiducial position.

Note that, in this case, although a vertical search position of ±0 is set for the deviation amount fiducial value 601 and the magnification (correction factor) is set to 1, different settings can be performed for the deviation amount fiducial value 601, as will be explained below.

FIG. 6B illustrates an example of the degree of difference before correction and the degree of difference after correction. Reference numeral 602 denotes the degree of difference before correction. In this case, as is shown in FIG. 4, an example in which the degree of difference is calculated for an oblique line object is shown. Additionally, although, in actual, the degree of difference for the two-dimensions is calculated by the horizontal search and the vertical search, the minimum value has been plotted with respect to the horizontal search.

In this case, as described above, pre-correction difference degrees 602, which are similar to each other, are calculated at a plurality of vertical search positions before correction for objects consisting of oblique lines, and in the example of FIG. 6A, it is determined that the degree of difference is the lowest at the position −5.

However, in the example of FIG. 6A, in one embodiment, the degree of difference becomes the lowest at the vertical search position ±0 for objects consisting of oblique lines in which the degrees of difference are similar. Accordingly, the deviation amount at the vertical search position ±0 is adopted as the deviation amount fiducial value 601. Reference numeral 603 denotes the degree of difference after correction, and it is determined that the degree of difference is the lowest at the search position ±0 by using the degree of difference after correction, and the degree of difference of the deviation amount fiducial value 601 is prioritized even for the objects consisting of oblique lines.

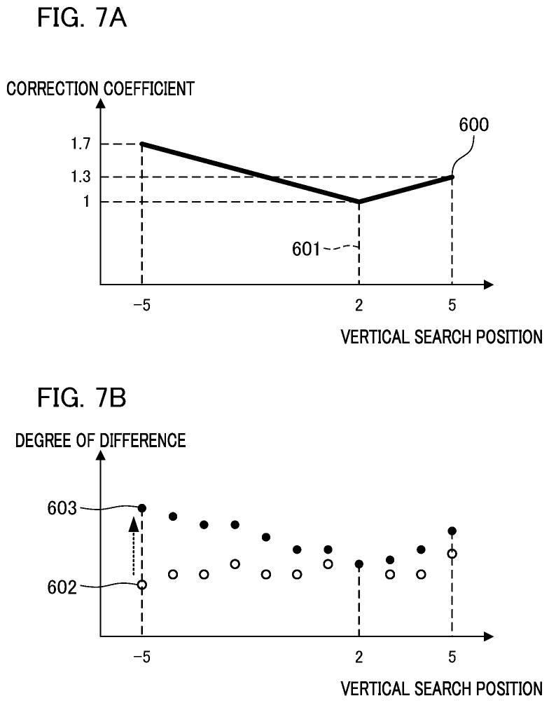

FIG. 7A and FIG. 7B are diagrams showing another example of the correction of the degree of difference in the correlation calculation unit. Although, in FIG. 6, the deviation amount fiducial value 601 is ±0, in FIG. 7, the deviation amount fiducial value 601 is positioned at +2, and, as is shown in FIG. 7A, the magnification for the correction coefficient 600 is 1 at the vertical search position of +2.

In FIG. 7B, an example of calculating the degree of difference for objects consisting of oblique lines such as those in FIG. 4 is shown, as in FIG. 6B. In FIG. 7B, since the deviation amount fiducial value 601 is set to +2, in the corrected difference 603, the vertical search position of +2 becomes the lowest degree of difference compared to the pre-corrected difference 602.

Here, an explanation regarding the settings of the deviation amount fiducial value 601 that was determined in FIG. 6 and FIG. 7 will be given. The amount of vertical deviation caused by the optical system includes static deviation, which is determined when the devices are assembled, or dynamic deviation, which fluctuates due to thermal fluctuations or other factors during operation after the static deviation. In one embodiment, the amount of the former static deviation is stored (held) as a set value in advance in the storage unit 112 of the distance image generating unit 102.

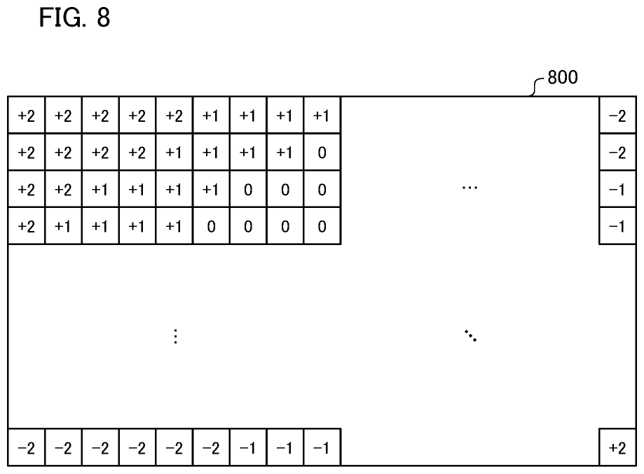

FIG. 8 is a diagram showing an example of the deviation amount fiducial value map 800 that is stored in the storage unit 112, and the amounts of static deviation are individually held for each pixel as the deviation amount fiducial value 601. Additionally, in the deviation amount fiducial value map 800 that is stored in the storage unit 112, a configuration in which writing is possible from an external I/F (not illustrated) may be adopted. Alternatively, it may be possible that the deviation amount fiducial value map 800 is stored in an external server or the like and acquired from the server.

Additionally, in one embodiment, the amount of static deviation is stored as data for each pixel, to serve as the characteristics of each pixel. Specifically, in one embodiment, information regarding a predetermined fiducial position is stored for each pixel in the first image. Consequently, the amounts of static deviation at the corresponding pixel positions can respectively be calculated when the degree of difference is calculated for each pixel.

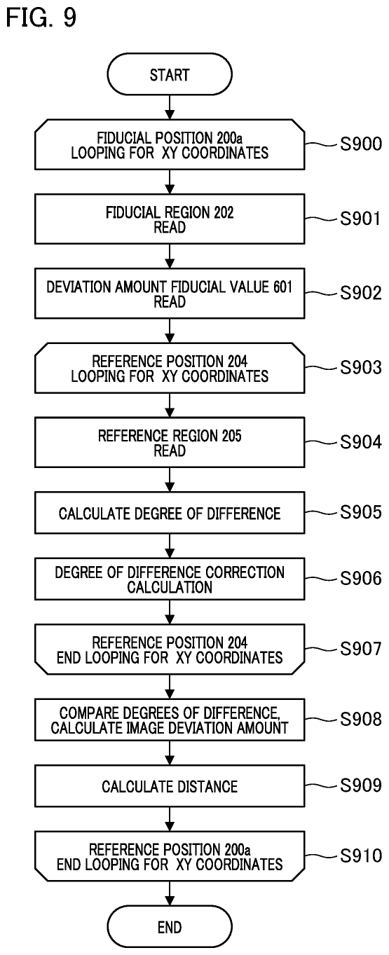

FIG. 9 is a flow chart showing the control flow in the first embodiment, and the correlation calculation unit 108, the image deviation amount calculation unit 109, the distance calculation unit 110, and the like perform processing as shown in FIG. 9 according to instructions from the supervising control unit 111. Note that the operations of each step in the flowchart in FIG. 9 are performed by the CPU serving as the computer in the supervising control unit 111 executing computer programs stored in the storage unit 112.

Note that, for example, the correlation calculation unit 108 performs the processes from steps S901 to step S902, step S904 to step S906, the image deviation amount calculation unit 109 performs step S908, and the distance calculation unit 110 performs step S909. Additionally, step S900, step S903, step S907, and step S910 are instruction steps that are performed by the supervising control unit 111.

In step S900, the supervising control unit 111 starts loop processing for the xy coordinates of the fiducial position 200a, and sequentially performs the processing for each of the coordinates. Additionally, in step S901, the correlation calculation unit 108 reads the data for the fiducial region 202 that is around the fiducial position 200a. In step S902, the correlation calculation unit 108 reads the deviation amount fiducial value 601 that is prepared for each pixel, which is stored in the storage unit 112.

In step S903, the supervising control unit 111 performs the loop processing for the plurality of reference positions 204, and sequentially performs processing for each region within the two-dimensional search region 300 as shown in, for example, FIG. 4. In step S904, the correlation calculation unit 108 reads the data for the reference region 205 around the selected reference position 204.

In step S905 (correlation acquisition step), the correlation calculation unit 108 calculates a degree of difference by using the data for the fiducial region 202 and the data for the reference region 205. That is, in step S905, correlation information between the image of the fiducial region in the first image and the image of the reference region corresponding to the fiducial region in the second image is obtained.

In step S906 (correction step), the correlation calculation unit 108 performs correction calculation on the degree of difference calculated in step S905. Specifically, multiplication by a correction coefficient such as the one exemplified in FIG. 6 and FIG. 7 is performed based on the deviation amount fiducial value 601 read in step S902. Thus, in step S906, the correlation information is corrected based on the distance in the second direction orthogonal to the first direction between the fiducial region and the reference region.

In step S907, the supervising control unit 111 repeats the loop until the processing related to the plurality of reference positions 204 shown in step S903 is completed. When the loop in step S907 is completed, in step S908 (image deviation calculation step), the image deviation amount calculation unit 109 compares the degrees of difference calculated for the plurality of reference regions 205 and calculates the image deviation amount.

Specifically, the image deviation amount between the image of the fiducial region and the image of the reference region is calculated based on the correlation information corrected in the correction step in step S906.

In step S909, the distance calculation unit 110 calculates a distance to the object based on the image deviation amount calculated in step S908.

In step S910, the supervising control unit 111 determines the end of the loop for the XY coordinates of the fiducial position 200a shown in step S900. Specifically, the processes from steps S900 to S910 are repeated until it is determined that the processes for all of the xy coordinates have been completed in step S910, and when the processes for all of the xy coordinates are completed, the flow in FIG. 9 ends.

As was described above, in the first embodiment, the distance to the object is calculated by referring to the plurality of reference regions 205 in the horizontal and vertical directions and performing template matching, and the vertical deviation of the optical system is corrected by using the deviation reference value 601 that is prepared in advance. Therefore, highly accurate distance measurement is possible even if an object including oblique lines is included.

Specifically, even when a plurality of reference regions with similar degrees of difference is present in the vertical direction, such as for an object including an oblique line, since greater weighting is applied to the degree of difference for the reference region the further away the reference region is from the deviation amount fiducial value 601, the influence of a degree of difference having low reliability can be reduced. Therefore, it is possible to appropriately correct vertical deviations caused by the characteristics of the optical system.

### Second Embodiment

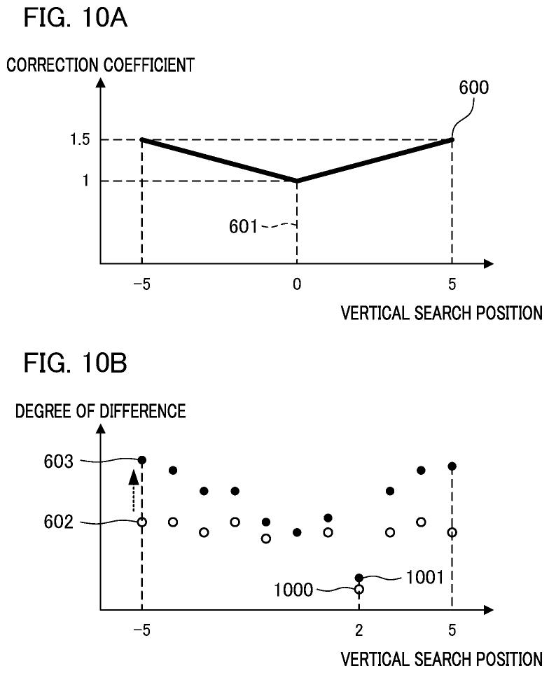

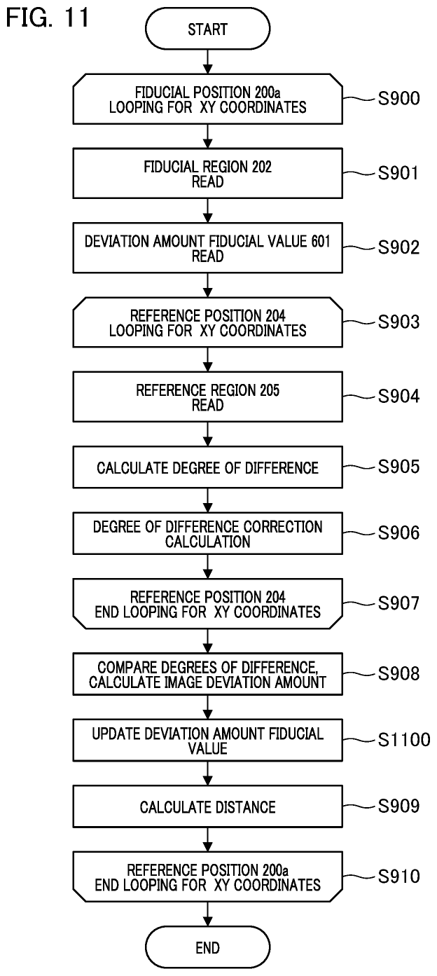

Next, the second embodiment will be explained with reference to FIG. 10 and FIG. 11. The overall configuration of the distance measuring device 100 that is shown in FIG. 1 is the same as that in the second embodiment. In the second embodiment, the deviation amount fiducial value 601 explained in the first embodiment is dynamically updated.

FIG. 10 is a diagram showing an example of the correction of the degree of difference in which vertical deviation is detected in a correlation calculation unit according to the second embodiment. Although, an example of calculating the degree of difference for an object including an oblique line is shown in FIG. 6, in FIG. 10, a case is shown in which an object that does not include an oblique line is included in the fiducial region 202. Additionally, in FIG. 10, an example is shown in which a degree of difference occurs in which a distinct difference occurs at, for example, the vertical search position +2.

As in the case of the first embodiment, it is assumed that the static deviation amount is stored (held) in advance in the storage unit 112 of the distance image generating unit 102 as a set value, for example, the predetermined deviation amount fiducial value 601 of a pixel is ±0. However, since the type, position, and distance of the object that is included in the image change with time, there are cases in which the degree of difference can be clearly and easily obtained and cases in which it cannot be.

In FIG. 10, an example of a timing when the degree of difference is clearly and easily obtained is shown. Reference numeral 1000 denotes the degree of difference that is the lowest from among the degrees of difference before correction, and reference numeral 1001 denotes the degree of difference after correction.

Although the deviation amount fiducial value 601 that is initially set is set at ±0, in the degree of difference after correction, the degree of difference at the vertical search position +2 is detected as the lowest. This is because further dynamic vertical deviation occurs from the position of ±0, which is the initially set deviation amount fiducial value 601.

The example in FIG. 10 shows that dynamic vertical deviation is detected at the position of +2, even in normal objects. In this case, in the second embodiment, since the image deviation amount 1001 at the vertical search position +2 is the smallest based on the degree of difference after correction, this is adopted as the image deviation amount, and, with respect to this pixel, the deviation amount fiducial value 601 that is stored in the storage unit 112 is updated from the initially set ±0 to +2.

FIG. 11 is a diagram showing a part of the control flow instructed from the supervising control unit 111 in the second embodiment. Note that the operation of each step in the flowchart in FIG. 11 is performed by the CPU, which serves as the computer in the supervising control unit 111, executing a computer program stored in the storage unit 112. Note that, in FIG. 11, the steps for which the reference numerals are the same as those in FIG. 9 perform the same processes as those in FIG. 9, and therefore explanations thereof will be omitted.

The difference from the flow chart in FIG. 9 is that, in the flow chart of FIG. 11, step S1100 is added to correspond to the dynamic update of the deviation amount fiducial value 601. In step S1100, the supervising control unit 111 updates the deviation amount fiducial value 601 that is stored in the storage unit 112 by using the image deviation amount that has been calculated in step S908. Specifically, information regarding the fiducial position is updated based on a reference position corresponding to the image deviation amount that has been calculated by the image deviation amount calculation unit.

### Other Embodiments

For example, the processing may also be made such that in the update step in step S1100, when a predetermined condition is satisfied, an update is not performed.

In the second embodiment, the processing may also be made such that whether or not the object included in the fiducial region 202 includes oblique lines equal to or higher than a predetermined ratio is determined, for example, by image recognition, and when oblique lines that are equal to or higher than a predetermined ratio are not included the update in step S1100 is performed.

Since the reliability of the degree of difference is low when the object included in the fiducial region 202 includes oblique lines equal to or higher than a predetermined ratio, the processing may also be made such that an update of the deviation amount fiducial value 601 that is stored in the storage unit 112 is not performed in this case.

Additionally, the processing may also be made such that when the degree of difference is equal to or higher than a predetermined threshold (correlation information is equal to or lower than a predetermined value), an update of the deviation amount fiducial value 601 that is stored in the storage unit 112 is not performed. This is because if the degree of difference is so high as to exceed a predetermined threshold, there is a possibility that the reliability of the calculated degree of difference will be low.

Additionally, the processing may also be made such that when the amount of change from the deviation amount fiducial value 601 that is stored in the storage unit 112 before updating is not within a predetermined range, an update of the deviation amount fiducial value 601 stored in the storage unit 112 is not performed. This is because when the amount of change in the standard deviation value is not within a predetermined range, there is a high possibility that the reliability of the degree of difference at that time will be low.

Additionally, for example, since the deviation amount fiducial value 601 is a result of changes over the years and does not change significantly in a short period of time, the processing may also be made such that in the case of updating the deviation amount fiducial value 601, if the elapsed time period since the latest update has not surpassed a predetermined time period, an update is not performed.

Additionally, the processing may also be made such that when the contrast of the image in the fiducial region is low, when there are a small number of structures, or when the reliability of template matching is low, an update is not performed with respect to the position of the pixel. Specifically, the processing may also be made such that when the contrast of the object is low, when it is determined by image recognition that there are a small number of structures, and when the reliability of template matching (reliability of the correlation information) is lower than a predetermined value, an update is not performed.

Note that, the reliability of template matching may be determined by analyzing the dispersion amount for the image, or the like. Alternatively, the processing may also be made such that if the image attributes are acquired by image recognition and, for example, a white line that causes an oblique line object is detected, an update is not performed.

Thus, when at least one condition from among the plurality of predetermined conditions is satisfied, in one embodiment, the deviation amount fiducial value 601 is not updated in step S1100.

Furthermore, as described above, the predetermined conditions include at least one case from among the case in which the image of the fiducial region includes oblique lines equal to or higher than a predetermined ratio, when the correlation information is equal to or lower than a predetermined value, and when the amount of change from the information regarding the fiducial position before the update is not within a predetermined range. Alternatively, the predetermined conditions may include at least one case from among the case in which the elapsed period of time since the latest update has not surpassed a predetermined time-period, the case in which the contrast of the image in the fiducial region is equal to or lower than a predetermined value, and the case in which the reliability of the correlation information is equal to or lower than a predetermined value.

Note that, in the above example, an example of applying weighting to the degree of difference (making the correlation information smaller) as the distance from a predetermined fiducial position is further away has been explained, with respect to the vertical direction (the second direction orthogonal to the first direction with parallax). However, whether or not oblique lines equal to or higher than a predetermined ratio are included in the fiducial region may be determined, by, for example, image recognition and the like, and the processing may also be made such that if the ratio is less than a predetermined ratio, weighting with respect to the vertical direction (correcting correlation information), as described above, is not performed.

Additionally, whether or not to correct the correlation information (for example, the degree of difference) in step S906 may be changed according to the attributes of the image in the fiducial region and the coordinates of the fiducial position.

Note that a parallax direction correction unit (not illustrated) that corrects the image deviation amount calculated by the image deviation amount calculation unit with respect to the first direction may be further provided. The parallax direction correction unit may correct the image deviation amount based on, for example, chromatic aberration information for the lenses 103a and 103b of the imaging unit. Additionally, the parallax direction correction unit may correct the image deviation amount based on the distribution state of each color and the contrast of each color included in the image of the reference region.

Additionally, an object in which the image deviation amount and shape are known may be imaged by the imaging unit, an image deviation amount may be calculated by the image deviation amount calculation unit, and the information regarding the difference between the calculated image deviation amount and the known image deviation amount may be stored in advance in a difference storage unit. The image deviation amount may be corrected based on the difference information held in advance in the difference holding unit.

Alternatively, a predetermined object of which the distance and shape are known may be imaged by an imaging unit, the distance may be calculated for each pixel by a distance calculating unit, and the information regarding the difference between the calculated distance and the known distance may be stored in advance in a difference storage unit. The distance may be corrected based on the difference information that is held in the difference holding unit in advance. Furthermore, the difference holding unit described above may be provided in the image processing apparatus or may be provided outside of the image processing apparatus.

Thus, dynamic vertical deviation due to the optical system can be efficiently corrected, and highly accurate distance measurement is possible. Specifically, when a normal object, such as a mark, is in the fiducial region 202, the image deviation amount and the distance are calculated using the normal object, and dynamic vertical deviation is detected.

Furthermore, when at least one condition of the above conditions is satisfied, the deviation amount fiducial value 601 is updated by using the detected vertical deviation, the detected vertical deviation can be used from the next time onward, and as a result, calculation efficiency is improved.

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the image processing apparatus through a network or various storage media. Then, a computer (or a CPU, an MPU, or the like) of the image processing apparatus may be configured to read and execute the program. In such a case, the program and the storage medium storing the program configure the present disclosure.

This application claims the benefit of Japanese Patent Application No. 2022-048205, filed on Mar. 24, 2022, which is hereby incorporated by reference herein in its entirety.

What is claimed is:

1. An apparatus comprising:
at least one processor; and
a memory coupled to the at least one processor storing instructions that, when executed by the at least one processor, cause the at least processor to function as:
an image acquisition unit configured to acquire a first image and a second image having parallax in a first direction;
a correlation acquisition unit configured to acquire correlation information between an image of a fiducial region in the first image and an image of a reference region corresponding to the fiducial region in a second image;
a correction unit configured to correct the correlation information based on a distance in a second direction orthogonal to the first direction, between the fiducial region and the reference region, and
a deviation calculation unit configured to calculate an image deviation amount between an image of the fiducial region and an image of the reference region, based on the corrected correlation information.

2. The apparatus according to claim 1,
wherein the fiducial region in the first image includes at least one fiducial position set in the first image, and the deviation amount is determined for each of the plurality of fiducial positions.

3. The apparatus according to claim 2,
wherein the reference region in the second image includes a plurality of reference positions set in the second image, and the correlation information is acquired for each reference position relative to the fiducial position.

4. The apparatus according to claim 3,
wherein the correlation acquisition unit sets the plurality of reference positions for each of the first direction and the second direction.

5. The apparatus according to claim 4,
wherein the correction unit makes the correlation information smaller the farther away the distance in the second direction between the fiducial region and the reference region is from a predetermined deviation amount fiducial value.

6. The apparatus according to claim 5,
wherein the at least one processor or circuit is further configured to function as:
a storage unit configured to store information regarding the predetermined deviation amount fiducial value for each pixel in the first image.

7. The apparatus according to claim 6,
wherein the at least one processor further functions as:
an update unit configured to update information regarding the deviation amount fiducial value, based on the reference position corresponding to the calculated image deviation amount.

8. The apparatus according to claim 7,
wherein the update unit selectively performs the update depending on whether a predetermined condition is satisfied.

9. The apparatus according to claim 8,
wherein the predetermined condition includes at least one case from among cases in which an image of the fiducial region includes an oblique line equal to or higher than a predetermined ratio, a case in which the correlation information is equal to or less than a predetermined value, a case in which a change amount from information regarding the fiducial position before the update is not within a predetermined range, a case in which an elapsed time period after the latest update has not surpassed a predetermined time period, a case in which a contrast of an image in the fiducial region is equal to or less than a predetermined value, and a case in which the reliability of the correlation information is equal to or less than a predetermined value.

10. The apparatus according to claim 1,
wherein whether or not the correction by the correction unit is performed is changed according to attributes of the image in the fiducial region or coordinates of the fiducial position.

11. The apparatus according to claim 1,
wherein the at least one processor further functions as:
a parallax direction correction unit configured to correct the calculated image deviation amount, with respect to the first direction.

12. The apparatus according to claim 11,
wherein the parallax direction correction unit corrects the deviation amount based on a chromatic aberration of a lens included in the image acquisition unit.

13. The apparatus according to claim 11,
wherein the parallax direction correction unit corrects the image deviation amount based on a distribution state of each color or a contrast of each color included in an image in the fiducial region.

14. The apparatus according to claim 1,
wherein the at least one processor further functions as:
a difference holding unit configured to hold difference information between an image deviation amount calculated by the deviation calculation unit for a predetermined object and the image deviation amount that is known for the predetermined object, and
wherein the correction unit corrects the image deviation amount based on the difference information held by the difference holding unit.

15. The apparatus according to claim 1,
wherein the at least one processor further functions as:
a distance calculation unit configured to calculate a distance to an object based on the image deviation amount.

16. The apparatus according to claim 15,
wherein the at least one processor further functions as:
a difference holding unit configured to hold difference information between a distance calculated by the distance calculation unit for a predetermined object and the known distance for the predetermined object, and
wherein the distance calculation unit corrects the distance based on the difference information held by the difference holding unit.

17. A method comprising:
acquiring a first image and a second image having parallax in a first direction;
acquiring correlation information between an image of a fiducial region in the first image and an image of a reference region corresponding to the fiducial region in the second image;
correcting the correlation information based on a distance in a second direction orthogonal to the first direction, between the fiducial region and the reference region, and
calculating an image deviation amount between an image of the fiducial region and an image of the reference region, based on the corrected correlation information.

18. The method according to claim 17, further comprising:
calculating a distance to an object based on the image deviation amount.

19. A non-transitory computer-readable storage medium configured to store a computer program comprising instructions for executing following processes:
acquiring a first image and a second image having parallax in a first direction;
acquiring correlation information between an image of a fiducial region in the first image and an image of a reference region corresponding to the fiducial region in the second image;
correcting the correlation information based on a distance in a second direction orthogonal to the first direction, between the fiducial region and the reference region, and
calculating an image deviation amount between an image of the fiducial region and an image of the reference region, based on the corrected correlation information.

20. The non-transitory computer-readable storage medium according to claim 19 further comprising:
calculating a distance to an object based on the image deviation amount.
